(19) United States
(12) Patent Application Publication
(10) Pub. No.: US 2009/0301261 A1
(43) Pub. Date: Dec. 10, 2009

(54) SNAP-TYPE CORKSCREW

(76) Inventor: Mario Cellini, Maniago (IT)

Correspondence Address: WENDEROTH, LIND & PONACK, L.L.P., 1030 15th Street, N.W.,, Suite 400 East, Washington, DC, 20005-1503, US

(21) Appl. No.: 12/311,490

(22) PCT Filed: Oct. 8, 2007
(86) PCT No.: PCT/EP2007/060650

§ 371 Date: Jun. 19, 2009

(30) Foreign Application Priority Data
Nov. 7, 2006 (IT) PN2006A000088

(51) Int. Cl. B67B 7/04

(52) U.S. Cl. 81/3.45

(57) ABSTRACT

The present invention refers to a snap-type corkscrew, i.e. a corkscrew that snaps open when it has to be used. A corkscrew according to the invention comprises a handle (1), a screw (16) that is pivotally associated to said handle (1), and an arm (14) that is in turn pivotally associated to said handle (1), said screw (16) and said arm (14) being movable between a first resting position thereof, in which the screw (16) and the arm (14) are at least partially lying upon each other, and a second operative position thereof. The inventive corkscrew is characterized in that it comprises actuation means (18) adapted to impart a movement to the screw (16) and the arm (14) causing them to displace from the resting position towards the operative or working position thereof, and in that it comprises retaining means (20, 220, 320, 420) adapted to positively retain the arm (14) or the screw (16) in their folded position against said handle (1) of the corkscrew.

The present invention refers to a snap-type corkscrew, i.e. a spring-out type corkscrew.

Corkscrews for drawing corks from bottles, as they have been known and used up to this moment, are usually provided with a handle, to which there are pivotally connected a screw, or spiral, for engaging the cork to be drawn and an arm provided with resting or abutting members. When the corkscrew is used to draw a cork from a bottle, such resting members are associated to the neck of the bottle so as to provide the fulcrum of a lever. While it is possible for the torque required to rotate the arm relative to the handle to be kept conveniently low by appropriate construction measures, so as to facilitate drawing the cork from the bottle, the torque needed to rotate the screw relative to the handle is on the contrary relatively high. This is basically due to the fact that the screw is a part that is normally subject to severe stress and forces when a cork is being drawn, so that the pivoting connection thereof must be sized and constructively designed accordingly, while also taking into due account the fact that, when in use, the screw has to perform rather short a rotation relative to the handle.

Usually, therefore, in view of arranging a corkscrew for it to be ready to draw a cork from a bottle, the user has to make use of both his/her hands in order to be able to displace the screw from the resting position thereof, in which the same screw lies extending along the handle, to a working position thereof, in which the screw comes to extend in a direction that is substantially orthogonal to the major dimension of the handle. It can be most readily appreciated that such procedure is particularly inconvenient to be carried out, especially by professional operators, such as for instance waiters or sommeliers, who are normally required to repeat the above-described procedure a lot of times during the day, possibly while having one hand already occupied in holding the bottle.

Such procedure is complicated to a further extent by the fact that it requires two separate movements to be performed, i.e. a first movement to pivotally move the arm away from the handle, and a second movement to pivotally bring the screw in a position extending substantially orthogonally to the same handle.

A further disadvantage of prior-art corkscrews lies in the fact that, in the above-described procedure followed to set the corkscrew ready for use, the screw has to be handled, i.e. taken out manually and this is neither easy nor convenient to be done, actually, considering both the fact that the screw being in the shape of a spiral does not offer any point for it to be conveniently seized with the hand, and the presence of a sharp point at the end of the same screw that may hurt the user.

The need is therefore generally felt for corkscrews to be available, which are so designed and constructed as to be able to be used in a really convenient and expedite manner using just, a single hand.

It is in fact a main object of the present invention to provide a corkscrew that is capable of doing away with the drawbacks and disadvantages generally encountered in prior-art designs.

Within such main object, it is a purpose of the present invention to provide a corkscrew that is effective in reducing the effort required for a user to be able to displace and arrange the screw in a position, in which it is capable of being inserted in a cork.

Another purpose of the present invention is to provide a corkscrew that ensures an improved convenience in use.

A further purpose of the present invention is to provide a corkscrew that is simple to manufacture and assemble.

Still another purpose of the present invention is to provide a corkscrew that is capable of making it definitely easier for a cork to be drawn from the neck of a bottle.

According to the present invention, these aims, along with further ones that will become apparent from the following disclosure, are reached in a corkscrew that incorporates the features and characteristics as defined and recited in claim 1 appended hereto.

Advantages and features of the present invention will anyway be more readily understood from the description that is given below by way of non-limiting example with reference to the accompanying drawings, in which:

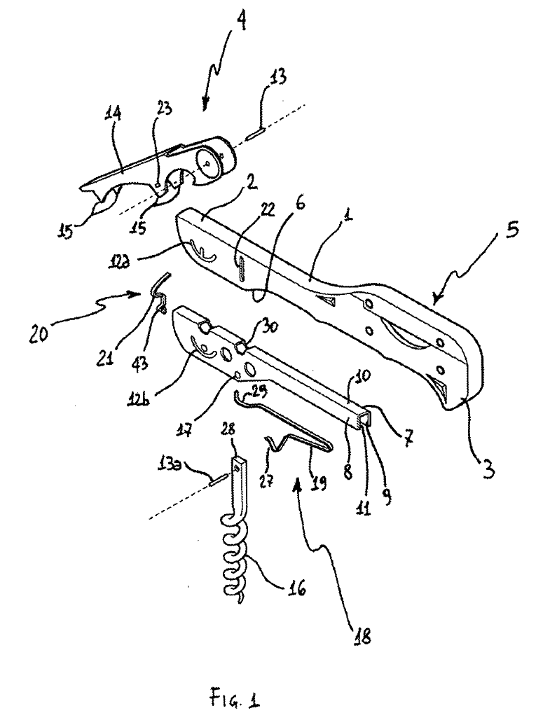

FIG. 1 is a perspective exploded view of a first embodiment of a corkscrew according to the present invention;

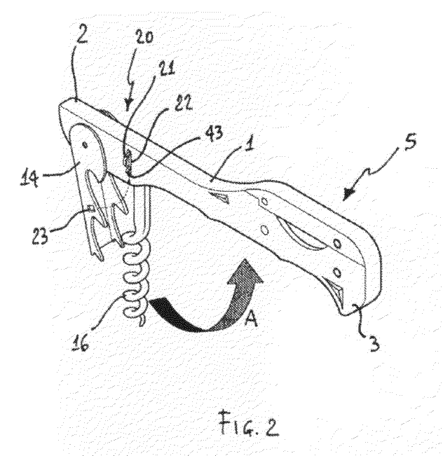

FIG. 2 is a view of the corkscrew shown in FIG. 1, in the assembled state thereof;

FIG. 3 is a perspective view of a second embodiment of a corkscrew according to the present invention;

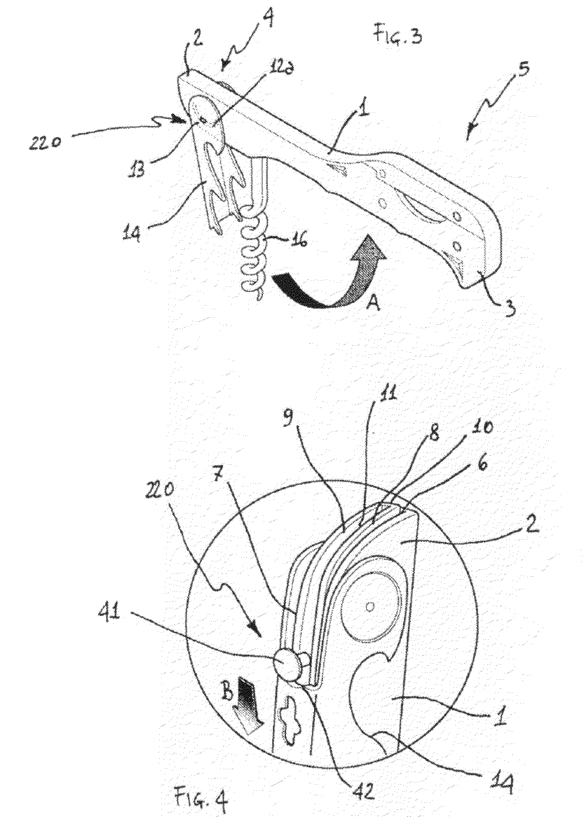

FIG. 4 is a perspective enlarged view of a detail of the corkscrew shown in FIG. 3;

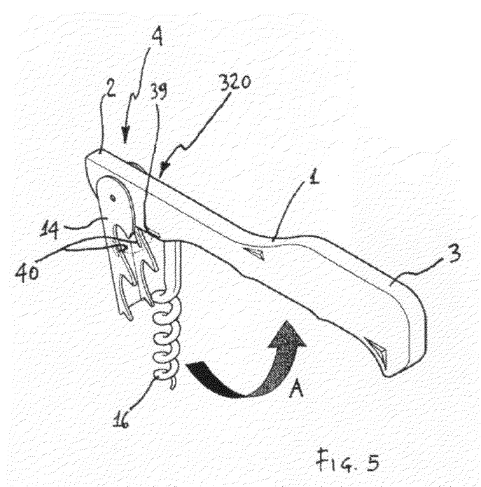

FIG. 5 is a perspective view of a third embodiment of a corkscrew according to the present invention;

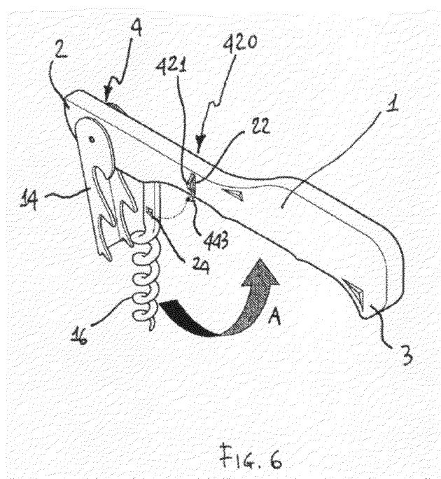

FIG. 6 is a perspective view of a fourth embodiment of a corkscrew according to the present invention;

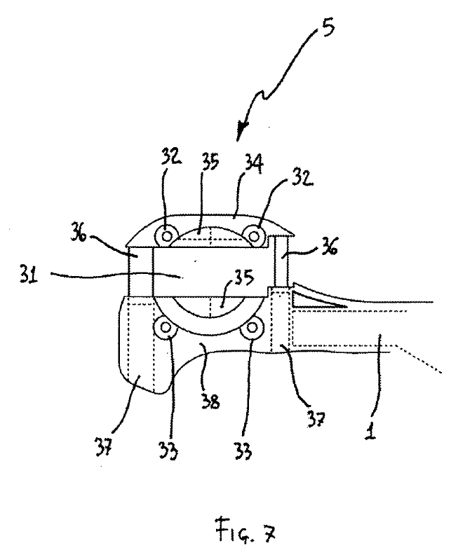

FIG. 7 is a front view of a cutting device for removing a film used to seal the neck of a bottle.

With reference to above-noted Figures, a corkscrew according to the present invention comprises a handle 1 featuring a first end portion 2, in which there are provided drawing means 4 for removing a cork from the neck of a bottle, and a second end portion 3, in which there may be provided a cutting device 5 for the removal of a film wrapped around the neck of a bottle to seal the mouth in which the cork is fitted, wherein this cutting device 5 shall be described in greater detail further on.

In the first end portion 2 thereof, the handle is provided with a cavity 6 that extends along the longitudinal direction of the handle 1. This cavity 6 is provided in view of receiving and accommodating a support structure 7 consisting of a pair of mutually facing walls 8 and 9, which are spaced from each other by a further wall 10 extending thereacross, so as to form a hollow space therebetween. The support structure 7, which is intended to enable the cork drawing means 4 to be attached to the handle 1, is preferably made by correspondingly forming and bending a sheet-metal blank at the press.

The walls 8 and 9 of the support structure 7, and correspondingly the handle 1, are provided with a pair of apertures 12a, 12b arranged so as to face each other in view of being able to pivotally receive a pin 13 associated to an arm 14. Such pin 13 extends across the cavity 6 and the hollow space 11, and enables the arm 14 to rotate relative to the handle 1 and the support structure 7 mounted within the cavity 6. The arm 14 is provided with one or more pairs of resting elements 15 that are effective in enabling the arm 14 to be associated to the neck of a bottle (not shown in the Figures) during a cork drawing operation. The pair of mutually facing apertures 12a, 12b may be provided in an appropriately elongated shape so as to allow the pin 13 to perform a translational motion that enables a cork to be drawn by displacing the fulcrum of the lever that is created by having the arm 14 resting against the neck of a bottle, and acting on the handle 1 accordingly.

A screw 16, which is adapted to be screwed into the body of a cork, is pivotally associated to the support structure 7, and correspondingly to the handle 1, by means of a pin 13a, which is in turn inserted in a pair of holes 17 provided in the walls 8 and 9 of the support structure 7.

The screw 16 and the arm 14 form the afore-cited drawing means 4, which—when the corkscrew is not being used—are folded, i.e. turned back in the direction of the arrow A shown in FIGS. 2, 3, 5 and 6 so as to be brought to lie along the body of the handle 1 in a resting, i.e. non-operative position thereof. In this resting position thereof, the arm 14 and the screw 16 are at least partially lying upon each other and, in particular, the arm 14 covers a portion of the screw 16. When the corkscrew has then to be used, in view of favouring the screw 16 and the arm 14 to displace from said resting position towards an operative position thereof, in which the screw 16 is arranged in a direction that is substantially orthogonal to the handle 1 and the arm 14 opens out relative to the handle 1, the corkscrew comprises actuation means 18 that preferably consist of elastic means 19, such as in particular a leaf spring or the like. These actuation means 18 are provided in such manner that the above-cited resting or non-operative position of the screw 16 is in fact a position of unstable equilibrium for the same screw. In FIG. 1, the leaf spring that forms the elastic means 19 comprises a first end portion 27, which is adapted to be associated to the head 28 of the screw 16, and a second end portion 29 that is intended to be accommodated in a recess 30 provided in the transverse wall 10 of the support structure 7. The body of the leaf spring itself extends within the hollow space 11.

The screw 16 is kept in the resting position thereof by the action of appropriate retaining means 20, 220, 320, 420, which are provided in order to temporarily retain the arm 14, or the same screw 16, against the handle 1. The arm 14 and the screw 16 being arranged to at least partially lie upon each other when in the resting position thereof and the instability of the screw 16 in such position ensure that, when the retaining means 20, 220, 320, 420 are released, the screw 16 and, as a result, the arm 14 tend to automatically move, i.e. swing out into the operative position thereof, thereby setting the corkscrew in the ready-for-use configuration thereof.

In a first embodiment of the inventive corkscrew, which is illustrated in FIGS. 1 and 2, the retaining means 20 retain the arm 14 against the handle 1 in a releasable manner. In this first embodiment of the corkscrew according to the present invention, the retaining means 20 comprise a detent device 21 in the form of a bayonet catch, which protrudes from an aperture 22 provided in the handle 1 and rests against the wall 8 of the support structure 7. When the arm 14 is brought into the resting position thereof, i.e. is brought to lie upon the body of the handle 1 in the direction indicated by the arrow A in FIG. 2, the screw 16 is caused to also move into such position owing to the same arm 14 interfering with the screw 16 when performing such movement. In this resting position thereof, the bayonet-type detent 21 is accommodated in an aperture 23 provided in the arm 14, thereby positively retaining the arm 14 against the handle. In particular, the bayonet-catch type detent device may include an elastic leaf provided with a tooth 43 that is adapted to engage said aperture 23 in the arm 14. The screw 16 is kept in a position of unstable equilibrium that corresponds to the above-mentioned resting position of the same arm 14.

Illustrated in FIGS. 3 and 4 is a second embodiment of the corkscrew according to the present invention, wherein this second embodiment substantially differs from the first one illustrated afore with reference to FIGS. 1 and 2 owing to the kind of retaining means 220 used. The arm 14 is pivotally connected to the handle 1 by means of a pin 13 that is capable of sliding with a translational motion along an aperture 12a provided with an elongated shape in the handle 1.

The retaining means 220 releasably retain the arm 14 against the handle 1 and comprise a detent device 41 that is adapted to set itself in an arrangement in which it is oriented orthogonally relative to the longitudinal extension of the handle 1, between the walls 8 and 9 of the support structure housed into the cavity 6 of the handle 1. When the arm 14 is displaced in the direction indicated by the arrow A in FIG. 3, i.e. moves towards the resting position thereof, it intercepts the screw 16 and causes it to displace in the same direction indicated by the arrow A.

As soon as the arm 14 reaches a position close to the resting one, the detent device 41 causes the arm 14 to displace towards the second end portion 3 of the handle 1, as indicated by the arrow B in FIG. 4. When the arm 14 eventually reaches the resting position thereof, the detent device 41 engages a receptacle 42 provided in the same arm 14, thereby locking it in place.

For the retaining means 220 to be then released, all it takes is displacing the arm 14 from the resting position thereof towards the second end portion 3 of the handle 1, as indicated by the arrow B in FIG. 4, so that the detent device 41 is able to disengage the receptacle 42. By acting upon the screw 16, the actuation means 18 will at this point cause both the screw 16 and the arm 14 to move into the afore-described operative position thereof.

Illustrated in FIG. 5 is a third embodiment of a corkscrew according to the present invention, wherein this third embodiment substantially differs from the other embodiments illustrated afore with reference to FIGS. 1 to 4 owing to both the kind of retaining means 320 used and the absence of the cutting device 5, although the latter—if desired—may well be provided, as this will be described further on. The retaining means 320 releasably retain the arm 14 against the handle 1 and, to this purpose, they include one or more projecting portions 39 that are adapted to engage a corresponding number of recesses 40 when the arm 14 is brought into its resting position with a movement following the direction indicated by the arrow A in FIG. 5. In particular, the projections 39 are provided on the handle 1 and the recesses 40 in the arm 14. Also in this embodiment of the inventive corkscrew, displacing the arm 14 in the direction indicated by the arrow A will cause the screw 16 to also displace towards the resting position thereof owing to said screw interfering with the movement of the arm 14.

Releasing the retaining means 320 will cause the screw 16 to displace from its resting position, which is a position of unstable equilibrium for the same screw 16, towards the operative position thereof, owing to the action of the actuation means 18, thereby setting the corkscrew in an arrangement in which it is ready for use.

FIG. 6 illustrates a fourth embodiment of the corkscrew according to the present invention, wherein the retaining means 420 releasably retain the screw 16 against the handle 1. This third embodiment substantially differs from the third embodiment illustrated afore with reference to FIG. 5 owing solely to the particular position of the retaining means 420. These retaining means 420 comprise a detent device 421 of the bayonet-catch type, which protrudes from an aperture 22 provided in the handle 1 and rests against the wall 8 of the support structure 7 (not shown in FIG. 6) in a manner similar to the one described with reference to the afore-illustrated first embodiment of the inventive corkscrew. The bayonet-catch type detent device 421 comprises a tooth 443 that is adapted to be received into a recess 24 provided in the body of the screw 16 when the latter is displaced to lie in the resting position thereof by moving it in the direction indicated by the arrow A in FIG. 6. When the retaining means 420 are then released, the actuation means 18 cause the screw 16 to displace from the resting position to the operative position thereof, in which it takes an orientation that is substantially orthogonal to the handle 1. The arm 14 is moved pivotally out into the operative position thereof owing to the movement of the screw 16 interfering with the same arm 14.

The actuation means 18 preferably impart an impulsive movement to the screw 16 and, owing to the screw 16 and the arm 14 lying at least partially upon each other, also to the arm 14. Anyway, the actual movement imparted by the actuation means 18 may be so selected as to more appropriately comply with particular needs or requirements, such as for instance a slow-sliding motion.

Illustrated in FIG. 7 is a cutting device 5 that may or may not be provided in connection with each one of the above-described embodiments of the corkscrew according to the present invention. Such cutting device 5 may be appropriately provided at a place located on the end portion 3 lying opposite to the end portion 2, on which there are provided means 4 for drawing a cork from the neck of a bottle.

This cutting device 5 is effective in allowing for a convenient removal of the film wrapped around the neck of the bottle in view of sealing the mouth in which the cork is fitted. To this purpose, the cutting device 5 comprises a stationary portion 38 provided in or integral with the handle 1, and a support 34 that is slidably associated to the latter by means of two guide members consisting of arms 36 that are integral with the support 34 and capable of sliding within apertures 37 provided in the stationary portion 38. The support 34 is movable relative to the stationary portion 38 between a resting position, in which the support 34 lies close against the stationary portion 38 and the arms 36 are fully inserted into the apertures 37, and a second operative position, in which the support 34 is spaced away from said stationary portion 38 and the arms 36 are fully extracted from the apertures 37, as this is best illustrated in FIG. 7.

The cutting device 5 comprises some cutting lips or blades 33, 32 having preferably a rounded shape. A first couple of cutting lips 33 is located on the stationary portion 38 of the handle 1, and a second couple of cutting lips 32 is located on the support 34.

The support 34 and the stationary portion 38 comprise cavities 35 configured in the shape of an arc of a circumference and so arranged as to face each other, so that, when the support 34 is in its working position (FIG. 8), they form a recess 31 that is appropriately sized so as to be able to receive an end portion of the neck of a bottle thereinto. When such end portion of the neck of a bottle is fitted into the recess 31, the cutting lips 32, 33—which are appropriately located and arranged so as to protrude into the recess 31—are capable of interfering with a film wrapped around the neck of the bottle, and used to seal the latter, thereby cutting it in a way that enables the cork fitted into such neck to be uncovered so as to allow the same cork to be then drawn and removed.

It will be readily appreciated that the number of the cutting lips 32, 33 used, as well as the conformation of the support 34 and the way in which it is connected to the stationary portion 38 of the handle 1, may of course be so selected as to best comply with actual needs and requirements. So, for instance, the support 34 may be hinged on to the handle 1 and the cutting lips or blades may be comprised of one or more rounded elements.

Fully apparent from the above description is therefore the ability of the present invention to effectively reach the aims and advantages cited afore, through the provision of a corkscrew that is able to facilitate cork drawing operations, i.e. to make it definitely easier, more convenient and expedient for a cork to be drawn from a bottle. The corkscrew according to the present invention is simple in its construction and overall structure, is easy to assemble, and may further be embodied in a variety of different forms, all of which equally effective. Furthermore, the movement of the cork drawing screw has been properly conditioned in view of reducing the effort required for the user to be able to set the screw in the operative position thereof. With a corkscrew provided in accordance with the present invention, a user is in fact able to use just a single hand to get the corkscrew ready for drawing a cork from the neck of a bottle.

It shall be appreciated that the materials used, as well as the shape and the sizing of the various parts, may each time be selected so as to more appropriately meet the particular requirements or suit the particular application.

1. Corkscrew comprising:
a handle (1),
a screw (16) that is pivotally associated to said handle (1),
an arm (14) that is in turn pivotally associated to said handle (1), said screw (16) and said arm (14) being movable between a first resting position thereof, in which the screw (16) and the arm (14) are at least partially lying upon each other, and a second operative position thereof, characterized in that it comprises actuation means (18) adapted to impart a movement to the screw (16) and the arm (14) causing them to displace from the resting position towards the operative or working position thereof, and in that it comprises retaining means (20, 220, 320, 420) adapted to positively retain the arm (14) or the screw (16) in their folded position against said handle (1) of the corkscrew.

2. Corkscrew according to claim 1, wherein said actuation means (18) are adapted to bring about a condition of unstable equilibrium for the screw (16) when the latter lies in said resting position thereof.

3. Corkscrew according to claim 1, wherein said actuation means (18) comprise elastic means (19).

4. Corkscrew according to claim 3, wherein said elastic means (19) are comprised of a leaf spring.

5. Corkscrew according to claim 1, wherein said retaining means (20, 220, 320, 420) comprise at least one projecting surface (39, 41, 43, 443) adapted to engage a counter-shaped surface (23, 24, 40, 42).

6. Corkscrew according to claim 5, wherein said retaining means (20) comprise a detent device (21) in the form of a bayonet catch, which consists of an elastic leaf associated to the handle (1) and provided with a tooth (43) that is adapted to engage an aperture (23) in the arm (14).

7. Corkscrew according to claim 1, wherein said retaining means (320) comprise at least one projecting portion (39) provided on the handle (1) and adapted to engage a corresponding recess (40) provided in the arm (14).

8. Corkscrew according to claim 1, wherein said arm (14) is pivotally associated to the handle (1) by means of a pin (13) adapted to perform a translational motion within an elongated aperture (12a) provided in said handle (1), and wherein said retaining means (420) comprise a detent device (41) provided in an arrangement in which it is oriented orthogonally relative to the longitudinal extension of the handle (1) within a cavity (6) extending along said longitudinal direction.

9. Corkscrew according to claim 1, wherein the screw (16) is kept in the resting position thereof by the arm (14) being positively retained onto the handle (1).

10. Corkscrew according to claim 1, wherein the screw (16) is kept in the resting position thereof by the same screw (16) being positively retained onto the handle (1).

11. Corkscrew according to claim 10, wherein said retaining means (420) comprise a detent device (421) of the bayonet-catch type, which is provided with a tooth (443) adapted to be received into a recess (24) provided in the screw (16).

12. Corkscrew according to claim 1, wherein the movement of the arm (14) towards the operative position thereof is brought about by the movement of the screw (16).

13. Corkscrew according to claim 1, wherein said actuation means (18) impart the screw (16) an impulsive movement towards the operative position thereof.

14. Corkscrew according to claim 1, wherein said actuation means (18) impart the screw (16) a slow-sliding movement towards the operative position thereof.

15. Corkscrew according to claim 1, wherein the handle (1) comprises a cutting device (5) for the removal of a film wrapped around the neck of a bottle to seal the mouth in which the cork is fitted.

16. Corkscrew according to claim 15, wherein said cutting device (5) comprises a stationary portion (38) and a support (34) that is movable relative to said stationary portion (38) between a first resting position and a second working position thereof.

17. Corkscrew according to claim 16, wherein the stationary portion (38) and the support (34) comprise cavities (35) arranged to face each other so as to form a recess (31) that is adapted to receive an end portion of the neck of a bottle thereinto when said support (34) is in said second working position thereof.

18. Corkscrew according to claim 15, wherein said cutting device (5) comprises at least one cutting lip (32, 33) having a rounded shape.

19. Corkscrew according to claim 2, wherein said actuation means (18) comprise elastic means (19).

20. Corkscrew according to claim 2, wherein said retaining means (20, 220, 320, 420) comprise at least one projecting surface (39, 41, 43, 443) adapted to engage a counter-shaped surface (23, 24, 40, 42).
